(19) United States
(12) Patent Application Publication
(10) Pub. No.: US 2014/0057570 A1
(43) Pub. Date: Feb. 27, 2014

(54) SYSTEMS AND METHODS FOR OPTIMIZING COMMUNICATION PERFORMANCE

(71) Applicant: Yigal Leiba, Holon (IL)

(72) Inventor: Yigal Leiba, Holon (IL)

(73) Assignee: Siklu Communication Ltd., Petach-Tikva (IL)

(21) Appl. No.: 13/592,467

(22) Filed: Aug. 23, 2012

(51) Int. Cl. H04B 17/00

(52) U.S. Cl. 455/63.4

(57) ABSTRACT

Various embodiments of a millimeter-wave wireless point-to-point or point-to-multipoint communication system which maintains a stable communication link even in the face of problems such as vibration or other mechanical disturbance to transceivers in the system or radio interference to the transmission beam produced by a transmitter and received by a receiver. The system comprises a transmitter, a receiver, a high-gain antenna, and allied equipment as described. In various embodiments, a beam is mechanically or electronically redirected to improve system performance. In various embodiments, the modulation schemes or coding schemes of the transmission are altered to improve system performance.

### BACKGROUND

In PTP and PTMP networks, transceivers at remote points are aligned with each other, such that a directional connection is achieved. However, all point-to-point (“PTP”) and point-to-multipoint (“PTMP”) wireless communication networks suffer from problems of link degradation. Such problems may be temporary or permanent. Such problems may be caused by vibration or other movement in the transmission pole, tower, or other structure that supports the radio transceivers. Such problems may also be caused by electromagnetic interference or other problems, either temporary or permanent, in the radio environment around the link.

The problem or vibration or other movement can arise from a variety of causes, including, among others, wind, vibration from passing vehicles, or shifting ground in which the supporting structure is anchored. Over time, the supporting structure may be subject to metal fatigue or other mechanical stress, which can exacerbate the condition, and increase the effects of the causative factors. If there is too much vibration at one of the transceivers, there will be too much movement in that transceiver for it to maintain communication with one or more of its matched remote transceivers. The result is a breakdown of communication during the time of the vibration. This problem is particularly severe in millimeter-wave communication networks, but the problem is not limited to such networks.

Solutions that have been offered to these mechanical problems included mechanical means of reducing vibration of the transceivers. One example would be the use of a stronger kind of material in the supporting structure. A second example would be the use of a more non-corrosive kind of material in the supporting structure. A third example would be the thickening, or otherwise strengthening, of the material in the supporting structure. A fourth example would be adding lines to the supporting structure, such as metal cables, buttresses, and the like. A fifth example would be the driving of the support structure deeper into the ground. A sixth example would be to add a kind of root system in that part of the structure beneath the level of the ground. These are all mechanical solutions. They can reduce the severity of the problem, but they cannot solve the problem. Even with these solutions, vibrations in transceivers of PTP and PTMP networks continue to create communication difficulties in such networks.

The problem of electromagnetic interference or other environmental disturbance may be caused by a great variety of causes, including, for example, solar radiation, or other radio transmissions in the area, radiation generated by power lines or electric motors, competing radio transmissions, or other causes. These problems, which are often of a temporary nature, are often solved by building into a communication link budget sufficient excess to deal with such problems. This solution is limited in that it is unable to deal with severe problems. It is also deficient in that it requires additional material, energy, and expense to be deployed on a permanent or semi-permanent basis, when in fact the problem, whatever its severity, may be of a temporary nature.

### SUMMARY

Described herein are systems and methods in PTP and PTMP wireless communication networks, wherein the network is engineered in such a manner as to maintain communication between remote transceivers, even in the face of problems such as vibrations, other mechanical problems, or electromagnetic interference, affecting one or more of such transceivers.

One embodiment is a millimeter-wave communication system that operates to optimize beam direction together with modulation and coding schemes. In one particular form of such an embodiment, the system includes a millimeter-wave receiver, and a millimeter-wave transmitter that is located away from the receiver and that maintains a wireless data link with the receiver via a millimeter-wave radio beam generated by a directional antenna that can generate the beam toward various configurable directions. In this particular form of such an embodiment, system is further operative to: (i) aim the millimeter-wave beam toward different directions, (ii) measure the performance of the wireless data link toward the different directions, (iii) set the beam toward the one of the directions that results in essentially the best system performance; and (iv) optimize further performance of said wireless data link by selecting modulation and coding schemes for the wireless data link. Such schemes may be selected according to one or more of various criteria.

One embodiment is a method for optimizing performance of a millimeter-wave communication system in which a wireless data link is conveyed via a beam of millimeter waves. In one particular form of such embodiment, the system detects degradation in the performance of a wireless data link. The system then performs a test procedure by changing, at least temporarily, the direction at which the transmitted beam is pointing, and measuring the resulting performance. According to a result of the test procedure, the system then selects a course of action for at least partially resolving the degradation. The selection is made from essentially two possible courses of action, in which the system may select either one action or the other, or rather both actions. One of these possible courses of action is optimizing the direction at which the beam is pointing. The second of these possible courses of action is optimizing modulation and coding schemes of the wireless data link.

One embodiment is a method for setting beam direction together with modulation and coding schemes in a millimeter-wave communication system. In one particular form of such embodiment, the system optimizes performance of a wireless data link during idle periods of the wireless data link. In some embodiments, performance is optimized by (i) aiming toward different directions a narrow millimeter-wave beam that conveys the wireless data link, (ii) measuring performance of the wireless data link toward the different directions, and (iii) setting the direction of the narrow millimeter-wave beam toward the measured direction that results in essentially the best performance of the system. In some embodiments, the system further optimizes performance of the wireless data link, by selecting modulation and coding schemes of the wireless data link such that substantially maximum data transmission rates are achieved.

### BRIEF DESCRIPTION OF THE DRAWINGS

The embodiments are herein described, by way of example only, with reference to the accompanying drawings. No attempt is made to show structural details of the embodiments in more detail than is necessary for a fundamental understanding of the embodiments. In the drawings:

FIG. 1A illustrates one embodiment of a millimeter-wave point-to-point (“PTP”) communication system;

FIG. 1B illustrates one embodiment of a millimeter-wave point-to-point (“PTP”) communication system with a radiation beam;

FIG. 1C illustrates one embodiment of a millimeter-wave point-to-point (“PTP”) communication system in which the direction of a radiation beam has been changed one or more times to allow a test procedure to be performed;

FIG. 1D illustrates one embodiment of a millimeter-wave point-to-point (“PTP”) communication system, with a radiation beam whose direction has been optimized on the basis of results from a test procedure;

FIG. 1E illustrates one embodiment of potential combinations of modulation schemes and coding schemes in a millimeter-wave point-to-point (“PTP”) communication system;

FIG. 2 illustrates one embodiment of electronic redirection of a radio beam by a phased array in a millimeter-wave point-to-point (“PTP”) communication system;

FIG. 3A illustrates one embodiment of a millimeter-wave point-to-point (“PTP”) communication system, with a radiation beam in a direction before mechanical change in the direction of the beam;

FIG. 3B illustrates one embodiment of a millimeter-wave point-to-point (“PTP”) communication system, with a radiation beam in a direction after mechanical change in the direction of the beam;

FIG. 4 illustrates a flow diagram describing one method for optimizing system performance in a millimeter-wave point-to-point (“PTP”) communication system; and

FIG. 5 illustrates a flow diagram describing one method for setting beam direction together with modulation schemes and coding schemes, in a millimeter-wave point-to-point (“PTP”) communication system.

### DETAILED DESCRIPTION

Throughout this written description and the claims, the term “beam” is exactly the same thing as “radiation pattern”. In all cases, the intent is that the transmission of a transmitter mounted on a supporting structure in a PTP or PTMP system, creates a particular configuration or pattern or radiation energy.

Throughout this written description and the claims, a “non-idle period” is a period of time during which a communication system is transmitting in an ordinary manner.

Throughout this written description and the claims, “reducing a level of modulation” means to change a modulation scheme such that after the change the data rate is lower, but the quality of the link (also known as the “robustness of the link”) is higher. Similarly, throughout this written description and the claims, “reducing a coding rate” means to change a coding rate such that after the change the data rate is lower, but the quality of the link (also known as the “robustness of the link”) is higher.

Throughout this written description and the claims, “MCS” is short for “modulation and coding schemes”. Exemplary but non-limiting modulation schemes discussed herein include QPSK and QAM, but it is understood that any communication modulation scheme would be acceptable. Exemplary but non-limiting coding rates associated with coding schemes discussed herein include ½, ⅔, ¾, and ⅚, but it is understood that any communication coding scheme would be acceptable. Examples of coding schemes include RS and Turbo codes or any forward error correction scheme or any erasure coding scheme. Although the term “MCS” including both the modulation schemes and the coding schemes, it is understood that in alternative embodiments it is possible to alter the modulation scheme but not the coding scheme, or the coding scheme but not the modulation scheme, or both the modulation scheme and the coding scheme.

Throughout this written description and the claims, “PTP” is short for “point-to-point”, and signifies a wireless communication system in which there is communication between a transmitter and a receiver which are located remotely from one another, and in which the planned communication path between the transmitter and the receiver is the “central path”.

Throughout this written description and the claims, “PTMP” is short for “point-to-multipoint”, and signifies a wireless communication system in which there is communication between a transmitter and each of two or more receivers, all of which receivers being located remotely from the transmitter, and in which the planned communication path between the transmitter and a particular receiver is the “central path” for that pair of transmitter and receiver.

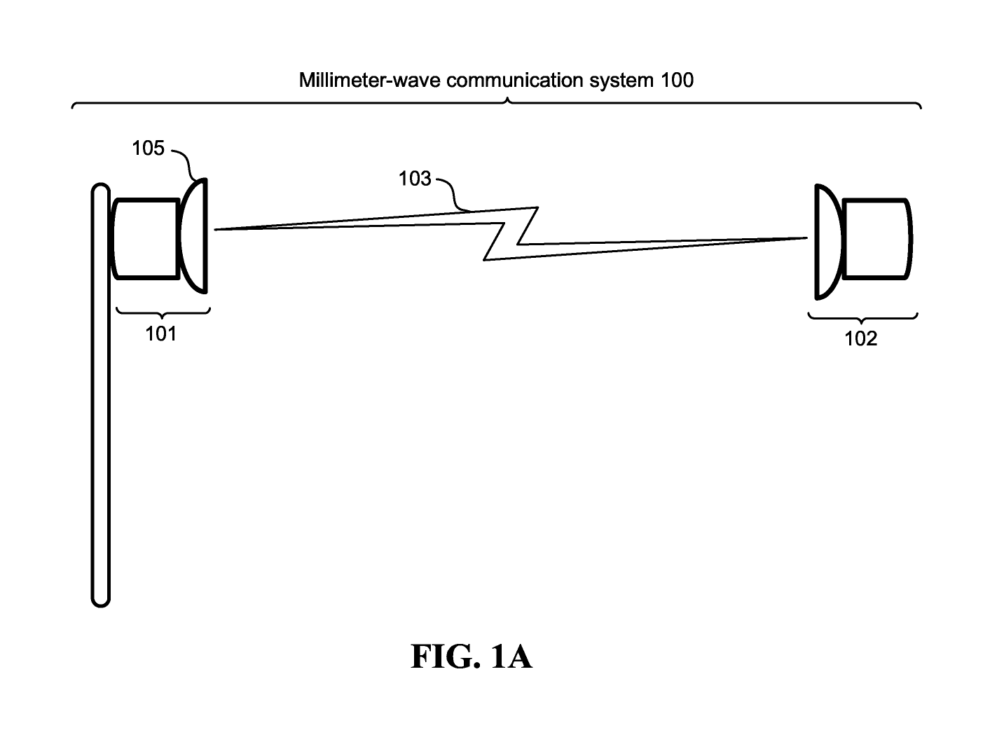

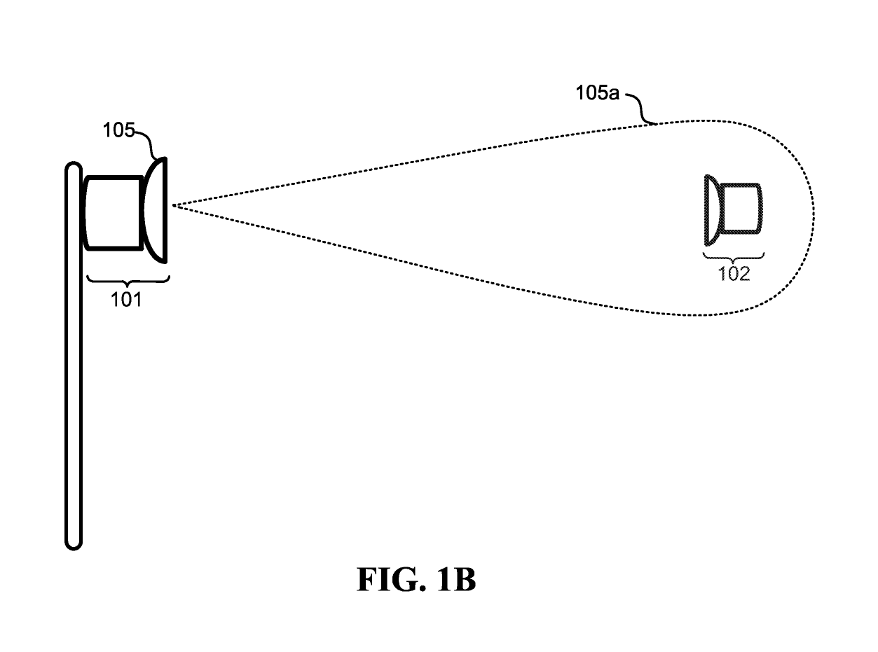

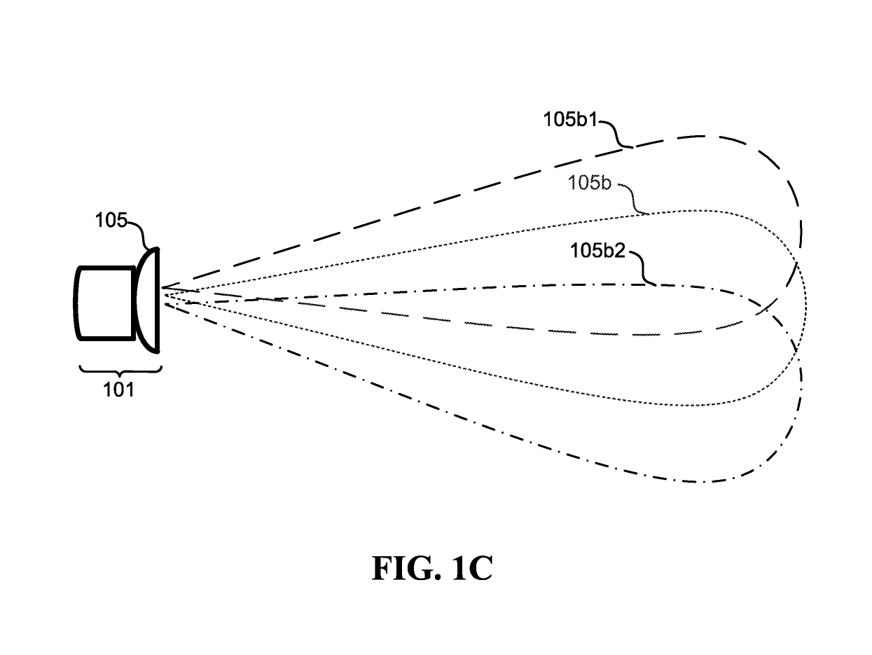

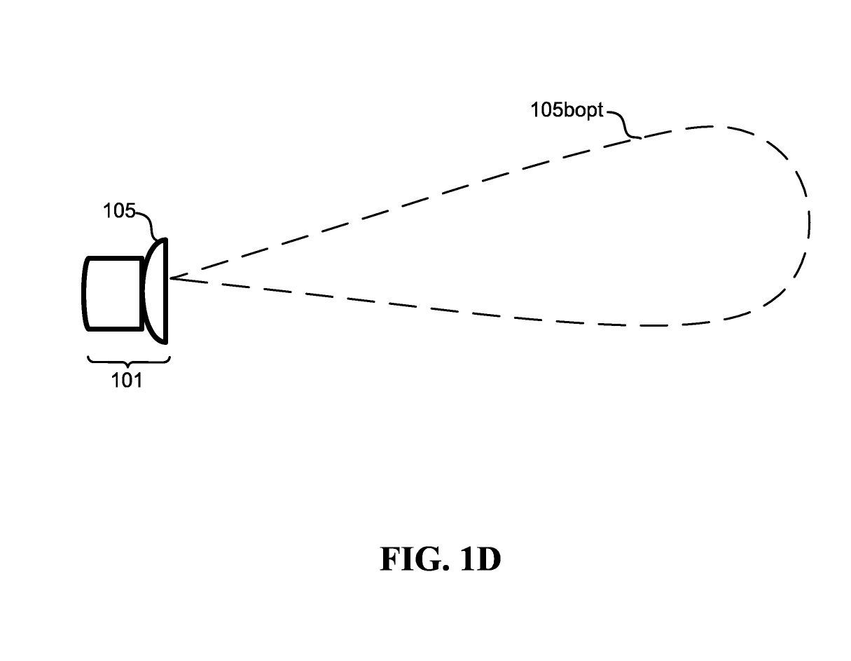

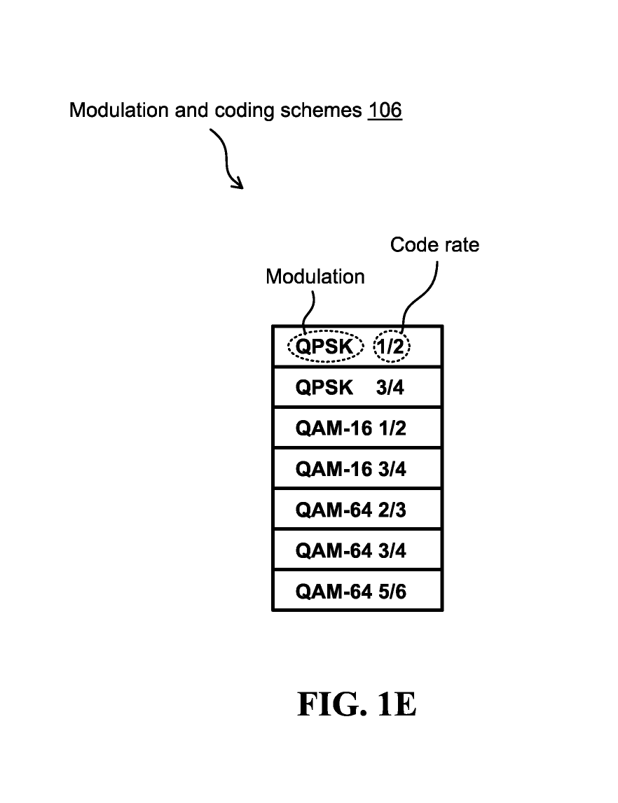

FIGS. 1A, 1B, 1C, 1D, 1E, 2, 3A, and 3B, inclusive, illustrate various embodiments of millimeter-wave communication systems.

FIG. 1A illustrates one embodiment of a millimeter-wave communication system 100. In FIG. 1A, the millimeter-wave communication system 100 includes a transmitter 101 which itself includes an antenna with a dish reflector 105, and a receiver 102. There is a link 103, which is conveyed over a directional beam from transmitter 101 to receiver 102.

FIG. 1B illustrates one embodiment of a millimeter-wave point-to-point (“PTP”) communication system 100 with a radiation beam 105a. In FIG. 1B, the millimeter-wave communication system 100 includes a transmitter 101 which itself includes an antenna with a dish reflector 105, and a receiver 102. The transmitter is transmitting a signal in the form of a radiation beam 105a, where the receiver 102 is located substantially in the center of the radiation beam 105a.

FIG. 1C illustrates one embodiment of a millimeter-wave point-to-point (“PTP”) communication system 100, which includes a transmitter 101 which itself includes and antenna with a dish reflector 105, in which the direction of a radiation beam has been changed one or more times to allow a test procedure to be performed. The original direction of the beam is shown as 105b. When the antenna with dish reflector 105 is pointed up or electronically steered up, the pointed up direction of the beam is shown in 105b1. When the antenna with dish reflector 105 is pointed down or electronically steered down, the pointed down direction of the beam is shown in 105b2. The system 101 tests the quality of the link 103 in each of the three beam directions, 105b, 105b1, and 105b2.

FIG. 1D illustrates one embodiment of a millimeter-wave point-to-point (“PTP”) communication system 101, with a radiation beam 105a whose direction has been optimized on the basis of results from a test procedure. The optimized beam 105b opt is the beam in a direction such that the communication link 103 between the transmitter 101 and the receiver 102 is optimized. Although receiver 102 is not shown in FIG. 1D, it is understood that receiver 102 is located substantially in the middle of optimized beam 105bopt.

FIG. 1E illustrates one embodiment of potential combinations of modulation schemes and coding schemes (MCS) 106 in a millimeter-wave point-to-point (“PTP”) communication system 100. In FIG. 1E, three modulation schemes are shown, which are QPSK, QAM-16, and QAM-64. It is understood that these modulation schemes are exemplary only, and any known modulation schemes could be used. In FIG. 1E, four coding rates associated with schemes are shown, which are ½, ⅔, ¾, and ⅚. It is understood that these coding rates are exemplary only, and any known coding rates associated with any known coding scheme could be used. The table in FIG. 1E arranges the MCS in a particular order, such that a higher lines in the MCS table allows a communication with a lower data rate, but a higher quality, than any of the lower lines. For these purposes, “higher quality” also means “more robust”. QPSK ½ is more robust, but provides a lower data rate, than any of the other MCS possibilities shown in FIG. 1E. For example, QAM-64 ⅚ is less robust, but provides a higher data rate, than any of the other MCS possibilities shown in FIG. 1E. For example, QPSK ¾ is less robust but provides a higher data rate than QPSK ½, but conversely QPSK ¾ is more robust but provides a lower data rate than all of the MCS possibilities listed in FIG. 1E below QPSK ¾.

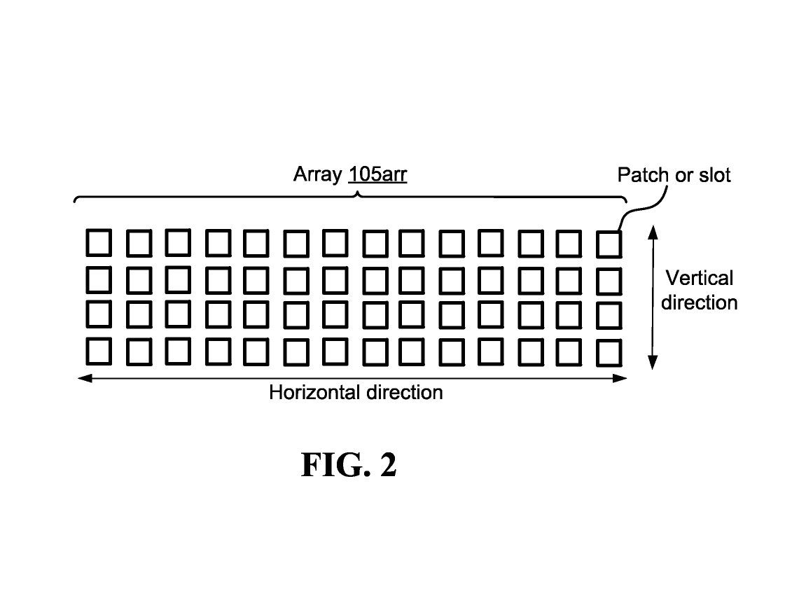

FIG. 2 illustrates one embodiment of electronic redirection of a radio beam by a phased array 105arr in a millimeter-wave point-to-point (“PTP”) communication system 100. In the phased array 105arr, various patches or slots are shown, arranged in a grid with a horizontal direction and a vertical direction. A phrased array, such as 105arr, may perform an electronic redirection or steering of a transmission beam 105a, thereby optimizing the link 103 between a transmitter 101 and a receiver 102, without mechanically changing the direction of the transmitter antenna 105 or the receiver antenna. In some embodiments, a transmission beam 105a is redirected both electronically by a phased array 105arr, and also by mechanical redirection of either a transmitter 101 or a receiver 102, or of both the transmitter 101 and the receiver 102.

The direction of a transmitter antenna 105 or a receiver antenna may be also be changed using beam-switching techniques.

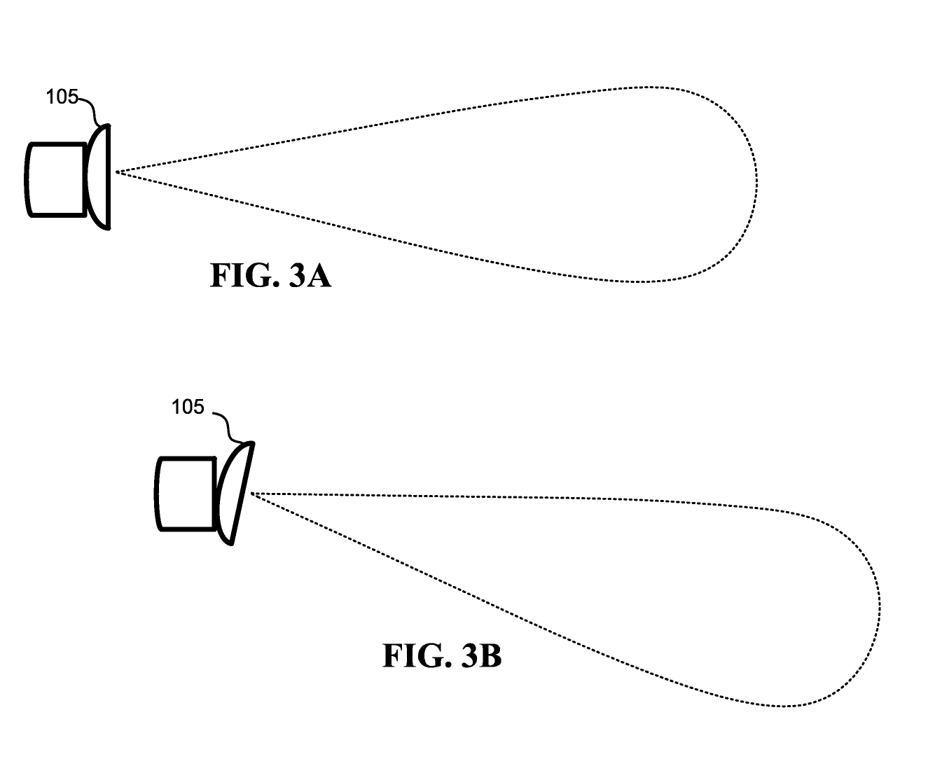

FIG. 3A illustrates one embodiment of a millimeter-wave point-to-point (“PTP”) communication system 100, with a radiation beam 105a in a direction before mechanical change in the direction of the beam 105a. In FIG. 3A, the transmitter 101, transmits the beam 105a over the antenna with dish 105, forming the beam shown in FIG. 3A.

FIG. 3B illustrates one embodiment of a millimeter-wave point-to-point (“PTP”) communication system 100, with a radiation beam 105a in a direction after mechanical change in the direction of the beam 105a. In FIG. 3B, the antenna with dish 105 has been mechanically redirected such that the direction of the beam 105a is lower than the direction of the beam 105a shown in FIG. 3A. It is possible, and occurs in some embodiments, to mechanically alter the direction of the antenna with dish of the receiver 102 rather than the transmitter antenna and dish 105. In other embodiments, it is possible to mechanically alter the direction of both the transmitter antenna and dish 105, and the receiver antenna and dish. Any or all of the embodiments of FIG. 3B may be enhanced with the addition of changes in the MCS, and in particular, a change to only the modulation scheme but not the coding scheme, or a change to only the coding scheme but not the modulation scheme, or a change to both the modulation scheme and the coding scheme.

In one embodiment, there is a millimeter-wave communication system 100 operative to optimize the direction of a beam 105a together with modulation and coding schemes 106. The system includes a millimeter-wave receiver 102, and a millimeter-wave transmitter 101 that is located away from said millimeter-wave receiver 102. The millimeter-wave transmitter 101 is operative to maintain a wireless data link 103 with the millimeter-wave receiver 102, via the millimeter-wave beam 105a. The millimeter-wave transmitter 102 includes a directional antenna 105 which is operative to generate the millimeter-wave beam 105a toward various configurable directions 105b, 105b 1, and 105b2. In one embodiment, the system 100 is further operative to: (i) aim the millimeter-wave beam 105a toward different directions 105b, 105b1, and 105b2, (ii) measure performance of the wireless data link 103 toward those directions, (iii) set the direction of the millimeter-wave beam 105a toward a direction, selected out of the different measured directions, which results in essentially best system performance; and (iv) optimize further performance of the wireless data link 103 by selecting modulation and coding schemes 106 of the wireless data link 103 according to some criterion or criteria.

In a first alternative embodiment of the millimeter-wave communication system 100 just described, the aiming, measuring, and setting, are done during idle periods of the wireless data link 103.

In a second alternative embodiment of the millimeter-wave communication system 100 described above, at least one of the criteria for selecting MCS is a target data transmission rate.

In a third alternative embodiment of the millimeter-wave communication system 100 described above, at least one of the criteria for selecting MCS is a target bit-error-rate or a target packet-error-rate.

In a fourth alternative embodiment of the millimeter-wave communication system 100 described above, at least one measure for system performance is a measure of a bit-error-rate or a packet-error-rate.

In a fifth alternative embodiment of the millimeter-wave communication system 100 described above, at least one measure for system performance is a measure of power received by the millimeter-wave receiver 102 from the millimeter-wave beam 105a.

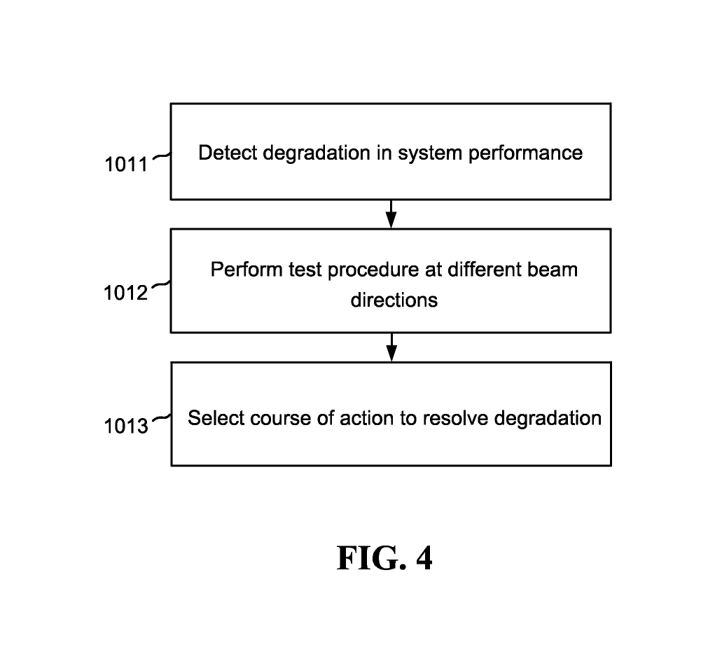

FIG. 4 illustrates one embodiment of a method for optimizing system performance in a In step 1011: the system 100 detects a degradation in the performance of a wireless link 103 which is being conveyed by the system 100 via a transmitter 101 sending a beam 105a of millimeter-waves to a receiver 102. In step 1012: the system 100 performs a tests procedure by at least temporarily changing the direction at which the beam 105a is pointing. The beam 105a is pointing in its original direction 105b, and is then moved either up 105b1 or down 105b2. Any number of up or down changes and tests may be part of the entire test procedure. In step 1013: the system 100 selects, according to at least one result of the test procedure, a course of action to solve at least partially the degradation. The course of action to be taken is selected from two basic alternatives, which may be chosen alternatively (that is, one alternative but not the other) or collectively (that is, both alternatives together). One alternative course of action is to optimize the direction at which the beam 105a is pointed. In this first alternative course of action, the beam 105a is directed toward an optimized direction 105bopt. The optimized direction 105bopt may be related to one of the test directions, or it may be a different direction, as per, for example, a fine-tuned direction that may be close to, but not exactly the same as, one of the tested directions. In other words, the directions used in the test procedure may or not include the optimized direction 105bopt which is the direction optimized from the first alternative course of action. The second alternative course of action is optimizing the MCS 106 of the wireless data link 103. Several exemplary, but non-limiting, examples of possible modulation schemes and coding schemes are set forth in FIG. 1E.

One embodiment is a method for optimizing performance of a millimeter-wave communication system 100. The system 100 detects degradation in the performance of a wireless data link 103 conveyed by the system via a beam 105a of millimeter-waves between a transmitter 101 and a receiver 102. The system 100 performs a test procedure which includes at least temporarily changing the direction of the beam 105a at least one time from an original direction 105b to an up direction 105b1 or a down direction 105b2. The direction of the beam 105a may be changed any number of times during the test procedure, both up and down, but also sideways, or in any other combination. On the basis of at least one result of the test procedure, the system 100 selects a course of action to resolve at least partially the degradation in performance of the wireless data link 103. One possible course of action is to change the direction of the beam 105a from its original direction 105b to either a new direction that is either up 105b1 or down 105b2. The new direction chosen may be one of the tested directions, or a different direction. The second possible course of action is to optimize the MCS 106 of the wireless data link 103 by changing either the modulation scheme or the coding scheme, or both the modulation scheme and the coding scheme. The system 100 may select the first course of action, or the second course of action, or both the first and the second courses of action.

In a first alternative embodiment to the method just described, the system 100 executes the course of actions or courses of actions selected. The result is that the degradation in the performance of the wireless data link 103 is resolved at least partially.

In a second alternative embodiment to the method for optimizing system performance described above, the performing of the test procedure includes the system 100 changing at least one time the direction at which the beam 105a is pointing, and the system 100 determining a level of performance of the wireless data link 103 for at least one of such changed directions.

In a first possible configuration of the second alternative embodiment just described to a method for optimizing system performance, the selecting of a course of action further includes the system 100 determining that at least one change in direction of the beam 105a does not result in resolving at least partially the degradation in performance of the wireless data link 103, and the system 100 thereby concluding that no change in direction is needed from the original direction 105b.

In one possible variation of the first possible configuration just described, the method further includes optimizing the MCS of the wireless data link 103, thereby at least partially resolving the degradation in the performance of the wireless data link 103.

In a second possible option of the first possible variation just described, optimizing the MCS further includes reducing the coding rate of the wireless data link 103, until the degradation of performance is at least partially resolved.

In a second possible configuration of the second alternative embodiment just described to a method for optimizing system performance, selecting the course of action further includes the system determining changing direction of the transmitter antenna 105 would resolve at least partially the degradation in performance of the wireless data link 103, and the system thereby concluding that a change in direction of the transmitter antenna 105 is needed.

In one possible variation of the second possible configuration just described, the method further includes the system 100 changing a direction at which the beam 105a is pointed to at least one of the directions tested, thereby (i) resolving at least partially the degradation in performance of the wireless data link 103, and also (ii) optimizing the direction at which the beam 105a is pointed.

In a third alternative embodiment to the method for optimizing system performance described above, optimizing the direction at which the beam 105a is pointed further includes changing the direction to one of the directions tested during the testing procedure.

In a first possible configuration of the third alternative embodiment just described, changing the direction at which the beam 105a is pointed is done using phased-array techniques.

In a second possible configuration of the third alternative embodiment described above, changing the direction at which the beam 105a is pointed is done by mechanically changing a direction at which a directional transmitter antenna 105 is pointed.

In a third possible configuration of the third alternative embodiment described above, changing the direction at which the beam 105a is pointed is done by using beam-switching techniques.

In a fourth possible configuration of the third alternative embodiment described above, changing the direction at which the beam 105a is pointed is done in only one direction, be it either the vertical direction or the horizontal direction.

In a fifth possible configuration of the third alternative embodiment described above, changing the direction at which the beam 105a is pointed is done in both the vertical and horizontal directions.

In a fourth alternative embodiment to the method for optimizing system performance described above, performing the test procedure is done during a period of time during which the system 100 does not convey data.

In a possible configuration to the fourth alternative embodiment just described above, performing the test procedure is done in-between transmission frames belonging to the wireless data link 103.

In a fifth alternative embodiment to the method for optimizing system performance described above, performing the test procedure is done during a period of time during which the system 100 conveys data that does not require decoding at reception.

In a sixth alternative embodiment to the method for optimizing system performance described above, degradation of performance of the wireless data link 103 is caused by an undesired change of direction at which a directional transmission antenna 105 is pointed.

In a first possible configuration to the sixth alternative embodiment just described above, the undesired change of direction is caused by wind.

In a second possible configuration to the sixth alternative embodiment just described above, the undesired change of direction is caused by mechanical vibration.

In a seventh alternative embodiment to the method for optimizing system performance described above, degradation of performance of the wireless data link 103 is caused by weather conditions.

In an eighth alternative embodiment to the method for optimizing system performance described above, the beam 105a is a narrow millimeter-wave beam, thereby making the system 100 particularly susceptible to undesired variations in directions toward which the beam 105a is directed.

In a first possible configuration to the eighth alternative embodiment described just above, the narrow millimeter-wave beam has a vertical beam-width or a horizontal beam-width of less than 10 degrees.

In a second possible configuration to the eighth alternative embodiment described just above, the narrow millimeter-wave beam has a vertical beam-width or a horizontal beam-width of less than 5 degrees.

In a third possible configuration to the eighth alternative embodiment described just above, the narrow millimeter-wave beam has a vertical beam-width or a horizontal beam-width of less than 2 degrees.

One embodiment is a method for setting beam direction together with modulation and coding schemes in a millimeter-wave communication system. In one particular embodiment, the method includes the system 100 optimizing performance of a wireless data link 103 belonging to the system 100, during idle periods of the wireless data link 103. The system 100 may do this by (i) aiming a narrow millimeter-wave beam 105a, operative to convey said wireless data link 103, toward different directions 105b, 105b1, 105b2, (ii) measuring performance of the wireless data link 103 toward such directions, and (iii) setting a direction of the narrow millimeter-wave beam 105a toward a direction, selected out of such different directions, which results in essentially the best performance of the system. The method also includes the system 100 further optimizing performance of the wireless data link 103 by selecting modulation and coding schemes 106 of the wireless data link 103 so as to result in substantially maximum data transmission rates.

In a first alternative embodiment of the method just described for setting beam direction and MCS, further optimizing performance of the wireless data link 103 in non-idle periods of the wireless data link.

In a second alternative embodiment of the method described above for setting beam direction and MCS, the method further includes repeating the steps of optimizing and further optimizing the performance of the wireless data link 103, thereby assuring substantially optimal performance of the wireless data link 103 over extended periods of time.

In a first possible configuration of the second alternative embodiment of the method described above for setting beam direction and MCS, the method further comprises the system 100 resolving a condition in which the direction of the narrow millimeter-wave beam 105a drifts over time.

In a second possible configuration of the second alternative embodiment of the method described above for setting beam direction and MCS, the method further comprises the system 100 resolving a condition in which the direction of the narrow millimeter-wave beam 105a changes suddenly.

In a third possible configuration of the second alternative embodiment of the method described above for setting beam direction and MCS, the method further comprises the system 100 resolving a condition in which an interference causes a reduction in the power in which the narrow millimeter-wave beam 105a is received.

In a fourth possible configuration of the second alternative embodiment of the method described above for setting beam direction and MCS, method further comprising the system 100 resolving a hybrid condition in which both (i) an interference is causing a reduction of power in which said narrow millimeter-wave beam 105a is received, and (ii) the direction of the narrow millimeter-wave beam 105a changes suddenly.

In a third alternative embodiment of the method described above for setting beam direction and MCS, the idle periods of the wireless data link 103 occur in-between transmission frames of such wireless data link 103.

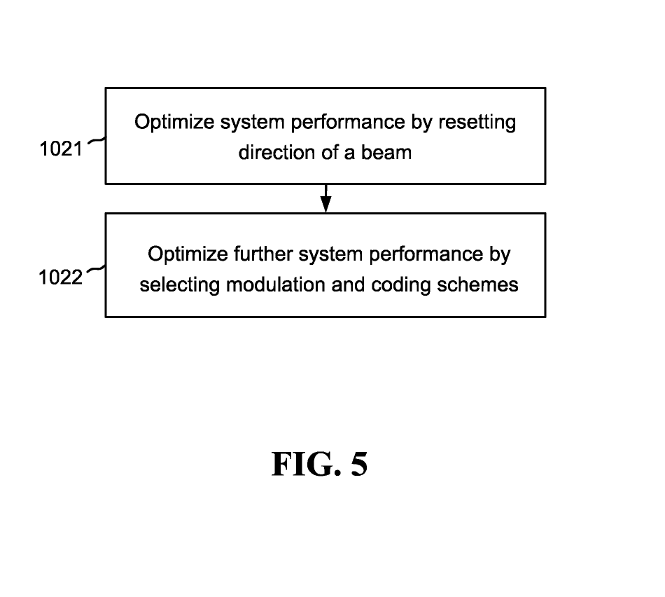

FIG. 5 illustrates one embodiment of a method for setting beam direction together with modulation and coding schemes in a millimeter-wave communication system. In step 1021: the system 100 optimizing performance of a wireless data link 103 belonging to the system 100, during idle periods of the wireless data link 103. The system 100 may do this by (i) aiming a narrow millimeter-wave beam 105a, operative to convey said wireless data link 103, toward different directions 105b, 105b1, 105b2, (ii) measuring performance of the wireless data link 103 toward such directions, and (iii) setting a direction of the narrow millimeter-wave beam 105a toward a direction, selected out of such different directions, which results in essentially the best performance of the system. In step 1022: the system 100 further optimizing performance of the wireless data link 103 by selecting modulation and coding schemes 106 of the wireless data link 103 so as to result in substantially maximum data transmission rates.

In this description, numerous specific details are set forth. However, the embodiments/cases of the invention may be practiced without some of these specific details. In other instances, well-known hardware, materials, structures and techniques have not been shown in detail in order not to obscure the understanding of this description. In this description, references to “one embodiment” and “one case” mean that the feature being referred to may be included in at least one embodiment/case of the invention. Moreover, separate references to “one embodiment”, “some embodiments”, “one case”, or “some cases” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein. Also herein, flow diagrams illustrate non-limiting embodiment/case examples of the methods, and block diagrams illustrate non-limiting embodiment/case examples of the devices. Some operations in the flow diagrams may be described with reference to the embodiments/cases illustrated by the block diagrams. However, the methods of the flow diagrams could be performed by embodiments/cases of the invention other than those discussed with reference to the block diagrams, and embodiments/cases discussed with reference to the block diagrams could perform operations different from those discussed with reference to the flow diagrams. Moreover, although the flow diagrams may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the embodiments/cases will sometimes be described in singular form for clarity. However, some embodiments/cases may include multiple iterations of a method or multiple instantiations of a mechanism unless noted otherwise. For example, when a controller or an interface are disclosed in an embodiment/case, the scope of the embodiment/case is intended to also cover the use of multiple controllers or interfaces.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the figures may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Accordingly, unless specifically indicated herein, the order and grouping of the steps is not a limitation of the embodiments/cases. Embodiments/cases described in conjunction with specific examples are presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. A method for optimizing performance of a millimeter-wave communication system, comprising:
detecting, by a millimeter-wave communication system, a degradation in performance of a wireless data link conveyed by said millimeter-wave communication system via a beam of millimeter-waves;
performing, by said millimeter-wave communication system, a test procedure comprising at least temporarily changing direction at which said beam is pointing; and
selecting, by said millimeter-wave communication system, according to a result of said test procedure, a course of action for at least partially resolving said degradation, from essentially two possible courses of action comprising: (i) optimizing direction at which said beam is pointing of said wireless data link.

2. The method of claim 1, further comprising executing said course of action, thereby at least partially resolving said degradation.

3. The method of claim 1, wherein the performing of said test procedure further comprising:
changing, by said millimeter-wave communication system, at least once, directions at which said beam is pointing; and
determining, at least for one of said directions, a level of performance of said wireless data link.

4. The method of claim 3, wherein said selecting of said course of action further comprising:
determining, by said millimeter-wave communication system, that said level of performance essentially does not result in at least partially resolving said degradation in performance of said wireless data link, thereby concluding that no change in direction is needed.

5. The method of claim 4, further comprising optimizing modulation and coding schemes of said wireless data link, thereby at least partially resolving said degradation in performance of said wireless data link.

6. The method of claim 5, wherein optimizing modulation and coding schemes further comprising:
reducing a level of modulation scheme of said wireless data link, until at least partially resolving said degradation.

7. The method of claim 5, wherein optimizing modulation and coding schemes further comprising:
reducing the coding rate of said wireless data link, until at least partially resolving said degradation.

8. The method of claim 3, wherein said selecting of said course of action further comprising:
determining, by said millimeter-wave communication system, that changing the direction of the transmitter antenna would resolve at least partially the degradation in the level of performance of the wireless data link, and thereby concluding that a change in direction is needed.

9. The method of claim 8, further comprising changing, by said millimeter-wave communication system, a direction at which said beam is pointing to the at least one of said directions, thereby: (i) at least partially resolving said degradation in performance of said wireless data link, and (ii) optimizing direction at which said beam is pointing.

10. The method of claim 1, wherein optimizing direction at which said beam is pointing further comprising changing a direction at which said beam is pointing to said direction which was at least temporarily changed.

11. The method of claim 10, wherein said changing of direction at which said beam is pointing is done using phased-array techniques.

12. The method of claim 10, wherein said changing of direction at which said beam is pointing is done by mechanically changing a direction at which a directional antenna belonging to said millimeter-wave communication system is pointing.

13. The method of claim 10, wherein said changing of direction at which said beam is pointing is done using beam-switching techniques.

14. The method of claim 10, wherein said changing of direction at which said beam is pointing is done only in one dimension.

15. The method of claim 10, wherein said changing of direction at which said beam is pointing is done in two dimension.

16. The method of claim 1, wherein the performing of said test procedure is done during a period in which said millimeter-wave communication system does not convey data.

17. The method of claim 16, wherein the performing of said test procedure is done in between transmission frames belonging to said wireless data link.

18. The method of claim 1, wherein the performing of said test procedure is done during a period in which said millimeter-wave communication system conveys data which does not require decoding at reception.

19. The method of claim 1, wherein said degradation of performance is caused by an undesired change of direction at which a directional antenna belonging to said millimeter-wave communication system is pointing.

20. The method of claim 19, wherein said undesired change of direction is caused by wind.

21. The method of claim 19, wherein said undesired change of direction is caused by a mechanical vibration.

22. The method of claim 1, wherein said degradation of performance is caused by weather conditions.

23. The method of claim 1, wherein said beam is a narrow millimeter-wave beam, thereby making said millimeter-wave communication system particularly susceptible to undesired variation in directions toward which said beam is directed.

24. The method of claim 23, wherein said narrow millimeter-wave beam has a vertical or horizontal beam-width of less than 10 degrees.

25. The method of claim 23, wherein said narrow millimeter-wave beam has a vertical or horizontal beam-width of less than 5 degrees.

26. The method of claim 23, wherein said narrow millimeter-wave beam has a vertical or horizontal beam-width of less than 2 degrees.

27. A method for setting beam direction together with modulation and coding schemes in a millimeter-wave communication system, comprising:
optimizing, by a millimeter-wave communication system, performance of a wireless data link belonging to said millimeter-wave communication system, during idle periods of said wireless data link, by (i) aiming a narrow millimeter-wave beam, operative to convey said wireless data link, toward different directions, (ii) measuring performance of said wireless data link toward said directions, and (iii) setting direction of said narrow millimeter-wave beam toward a direction, selected out of said different directions, which results in essentially best performance; and
optimizing further, by said millimeter-wave communication system, performance of said wireless data link, by selecting modulation and coding schemes of said wireless data link such as to result in substantially maximum data transmission rates.

28. The method of claim 27, wherein optimizing further performance of said wireless data link is done in a non-idle periods of said wireless data link.

29. The method of claim 27, further comprising repeating the steps of optimizing performance and further optimizing performance of said wireless data link, thereby assuring substantially optimal performance of said wireless data link over extended periods of time.

30. The method of claim 29, further comprising: resolving, by said millimeter-wave communication system, a condition in which the direction of said narrow millimeter-wave beam drifts over time.

31. The method of claim 29, further comprising: resolving, by said millimeter-wave communication system, a condition in which the direction of said narrow millimeter-wave beam changes suddenly.

32. The method of claim 29, further comprising: resolving, by said millimeter-wave communication system, a condition in which an interference causes a reduction of power in which said narrow millimeter-wave beam is received.

33. The method of claim 29, further comprising: resolving, by said millimeter-wave communication system, a hybrid condition in which both (i) an interference is causing a reduction of power in which said narrow millimeter-wave beam is received, and (ii) the direction of said narrow millimeter-wave beam changes suddenly.

34. The method of claim 27, wherein said idle periods of said wireless data link occur in-between transmission frames of said wireless data link.

35. A millimeter-wave communication system operative to optimize beam direction together with modulation and coding schemes, comprising:
a millimeter-wave receiver; and
a millimeter-wave transmitter located away from said millimeter-wave receiver and operative to maintain a wireless data link with said millimeter-wave receiver via a millimeter-wave beam, comprising a directional antenna operative to generate said millimeter-wave beam toward configurable directions;
wherein the millimeter-wave communication system is further operative to: (i) aim said millimeter-wave beam toward different directions, (ii) measure performance of said wireless data link toward said directions, (iii) set direction of said millimeter-wave beam toward a direction, selected out of said different directions, which results in essentially best performance; and (iv) optimize further performance of said wireless data link, by selecting modulation and coding schemes (MCS) of said wireless data link according to a criterion or criteria.

36. The system of claim 35, wherein said aiming, measuring, and setting, are done during idle periods of said wireless data link.

37. The system of claim 35, wherein at least one of the criteria for selecting the MCS is a target data transmission rates.

38. The system of claim 35, wherein at least one of the criteria for selecting the MCS is a target bit-error-rate or a target packet-error-rate.

39. The system of claim 35, wherein at least one measure for system performance is a measure of a bit-error-rate or a packet-error-rate.

40. The system of claim 35, wherein at least one measure for system performance is a measure of power received by said millimeter-wave receiver from said millimeter-wave beam.
